(19) United States
(12) Patent Application Publication
(10) Pub. No.: US 2010/0018722 A1
(43) Pub. Date: Jan. 28, 2010

(54) OVERHEAD SERVICING OF MACHINES

(75) Inventors: William R. Phillips, Williamsburg, VA (US); William J. Price, Newport News, VA (US); Richard W. Johnson, Yorktown, VA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NORTHROP GRUMMAN SHIPBUILDING, INC., Newport News, VA (US)

(21) Appl. No.: 12/500,360

(22) Filed: Jul. 9, 2009

Related U.S. Application Data
(60) Provisional application No. 61/083,078, filed on Jul. 23, 2008.

(51) Int. Cl. A62C 37/08; E04G 3/28; B66C 11/02

(52) U.S. Cl. 169/37; 182/36; 212/291; 182/19

(57) ABSTRACT

Provided are apparatuses, systems, methods, computer readable storage media and other means for performing overhead service of machines. A staging assembly may be used that includes one or more platforms, each having a bottom surface, a floor, and two or more railing support structures. The staging assembly can be suspended, using a suspension system, from one or more support structures disposed on a ceiling. One or more driving means can also be used to drive the staging assembly or other equipment (such as a hoist assembly) along a path that may be defined by a support structure. The driving means can also be automated and/or activated in response to, for example, one or more commands generated by a central control processor. The central control processor, staging assemblies and/or other equipment can all include computer readable media which comprises instructions to perform various tasks, some examples of which are discussed herein.

### CROSS-REFERENCE TO RELATED APPLICATIONS.

This application is related to and claims the benefit of U.S. Provisional Patent Application No. 61/083,078, filed Jul. 23, 2008, which is incorporated herein by reference in its entirety.

### TECHNICAL FIELD

Embodiments of the present invention relate generally to enabling the performance of overhead services and, in some embodiments, actually performing overhead services in a hangar bay using suspended platforms and various pieces of equipment.

### BACKGROUND

For decades, people have been performing overhead construction, maintenance, mechanical services, inspections, and other types of services in aircraft carrier hangar bays, ground-based hangar bays, and various other locations. These “services” (as they are collectively referred to herein) are performed on, for example, aircraft (including airplanes and helicopters), boats, ground-based vehicles, other types of vehicles and large machines, large parts of such vehicles and machines, equipment, weapons, other mechanical objects and/or anything else that may need to be serviced in, for example, a hangar bay. (For simplicity and to avoid unnecessarily overcomplicating the discussion, any object that may be serviced is referred to herein as a “machine” or “machines.”)

Overhead construction and other services often involve pre-staging work (such as setting up scaffolding, etc.), which can require much time to set up—just to prepare for the service(s) actually needed. For example, some service projects require multiple instances of overhead staging apparatuses that have to be individually constructed around a particular machine or machines to enable the workers to service the particular machine or machines. Moreover, the pre-staging often requires using and moving heavy materials in a confined space (sometimes while out to sea). In addition, the construction, assembly, and disassembly of the staging scaffolding can be redundant, as the construction of the scaffolding or other pre-staging work may need to be repeated each day or even each shift for, e.g., safety or other reasons.

Once built, current overhead staging (such as scaffolding) is usually stationary or has limited mobility. This can make performing services on various aircraft and other vessels relatively difficult. It may also cause the performance of service to span long periods of time, such as many days, leading to the hangar bays becoming crowded, thereby making some tasks more complex. For example maneuvering cranes and other similar machines around various aircraft and vessels in a hangar bay, when out to sea, can be a challenging task. Moreover, the hangar bay can store multi-million dollar aircraft, equipment, etc., which may require even greater care to be exercised when maneuvering.

### BRIEF SUMMARY OF THE DISCLOSURE

Embodiments of the present invention provide, among other things, methods, apparatuses, systems, computer readable media and other means for performing overhead services. Some embodiments of the invention, for example, comprise a system designed to incorporate mobile staging in a hangar bay, to help enable the performance of new construction, in-service maintenance, inspection and any other service that equipment may need. For example, some systems can comprise one or more rails and platforms installed directly in the overhead area (e.g., ceiling) of a ground-based hangar bay, an aircraft carrier's hangar bay, other similar area, warehouse, and/or anything else used to house and/or produce one or more machines. Although a hangar bay is often referred to throughout this disclosure, one skilled in the art would appreciate that some embodiments of the present invention can be implemented in anything used to house and/or produce one or more machines.

The one or more platforms may be suspended from at least one overhead support rail (which may be intended to be permanently, temporarily or semi-permanently installed in the hangar bay). The platform(s) can operate in a manner that provides various types of mobile staging. For example, platforms may be configured to act as service platforms (to perform in-service inspection, maintenance, construction, and/or other types of services on aircraft, vessels, vehicles, machinery, and/or other machines in a hangar bay).

Platforms may also be configured to move (e.g., lift, drag, pull, push, slide, roll, a combination thereof, and/or by any other means) equipment about the hangar bay. Additionally, at least some of the platforms discussed herein may provide for maintenance, inspection, and/or other services without the obstructions sometimes associated with legacy mobile staging for aircrafts, vehicles, vessels, equipment, machinery, and/or the like.

In some exemplary embodiments of the present invention, the platform is part of a staging assembly that includes enough room and strength to support at least one service worker. Some platforms may be designed to provide support for two, three or more service workers with any equipment (e.g., tools, lighting, fire extinguisher, lifts, etc.) they may need to perform a service.

The staging assembly can comprise a suspension system that allows each platform to be suspended from the ceiling or other structure in the overhead area of a hangar bay. In some embodiments, the platform may hang from and travel along a path defined by the railing or high beam support system disposed in the overhead area of a hangar bay. The suspension system can comprise, for example, at least one beam crawler (which may include one or more wheels) configured to engage the flanges of the railing or high beam structure disposed in the overhead area of the hangar.

The platform may also comprise an expanded floor that may allow the service worker(s) to see through the floor. In other words, a service worker can observe aircraft, vehicles, vessels, machinery, other workers and/or anything else below the suspended platform while suspended on the platform. The expanded floor may also assist in the performance of various services such as, for example, inspection and maintenance, since a service worker or other piece of equipment may be able to reach and/or pass through the platform's floor (or a portion thereof). An example of an expanded floor is shown below in connection with, e.g., floor 620 of FIG. 6.

In some embodiments of the present invention, the apparatus may comprise two or more platforms in proximity with each other. Together, the length of the apparatuses, when positioned next to each other, may span the entire width or length of the hangar bay, or a portion thereof (e.g., at least 90% of the width and/or length). In this regard and according to some embodiments, the movement and/or operation of two or more platforms may be coordinated automatically by a specialized computer system and/or mechanical locking system, thereby allowing the two or more platforms to travel at the same time and together (through, e.g., the overhead area of a hangar bay) along a path defined by two or more rails or other high beam structures. The movement and/or operation may be such that the two or more platforms may move and/or otherwise operate independently from one another.

In some embodiments of the present invention, the platform may comprise a mobile hoist assembly. The hoist assembly may be mounted on, for example, the under side or any other portion of the platform (e.g., the platform's floor, side rail, one or more other portions of the platform, or combination thereof). The hoist assembly may be used to, for example, lift, move and/or otherwise transport equipment, machines, and/or any other loads throughout the hangar bay. In some embodiments, a hoist assembly may be suspended directly from the railing and/or high beam support system (in addition to or instead of a platform).

In some embodiments of the present invention, each platform may comprise one or more fire extinguishing equipment assemblies. The one or more fire extinguishing equipment assemblies can be disposed on various areas of the platform.

In some embodiments of the present invention, the platform may comprise one or more lighting structure assemblies. The one or more lighting structure assemblies may be disposed on various areas of the platform.

### BRIEF DESCRIPTION OF THE DRAWINGS

Having thus described the invention in general terms, reference will now be made to the accompanying drawings, which are not necessarily drawn to scale, and wherein:

FIGS. 1-4 show examples of service platforms in a hangar bay according to exemplary embodiments of the present invention;

FIG. 5 shows an example of multiple platforms moving independently according to exemplary embodiments of the present invention;

FIG. 6 shows an example of a platform comprising a hoist assembly according to exemplary embodiments of the present invention;

FIG. 7 shows an example of a hoist assembly separate from the platform according to exemplary embodiments of the present invention;

FIG. 8 shows an example of a platform comprising fire extinguishing equipment according to exemplary embodiments of the present invention;

FIG. 9 shows an example of a platform comprising lighting structure assemblies according to an exemplary embodiment of the present invention;

FIGS. 10A-B show an example of a suspension system according to an exemplary embodiment of the present invention; and

FIGS. 11A-B show flowcharts of a method and/or operation of a computer program product according to exemplary embodiments of the invention.

### DETAILED DESCRIPTION OF THE DRAWINGS

For years, scaffolding and other staging overhead staging (such as scaffolding) were used to perform services on equipment in a hangar bay. It was and often still is an integral part to any hangar bay, which service workers and the engineers who design hangar bays have accepted and plan around. Some embodiments of the present invention are designed and/or configured to provide an alternative to scaffolding and other types of commonly used overhead staging.

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

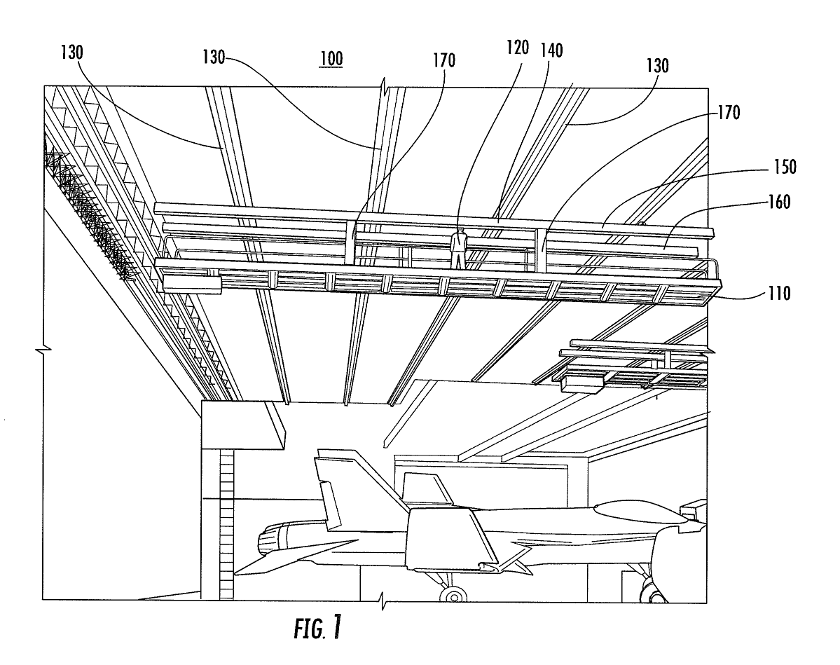

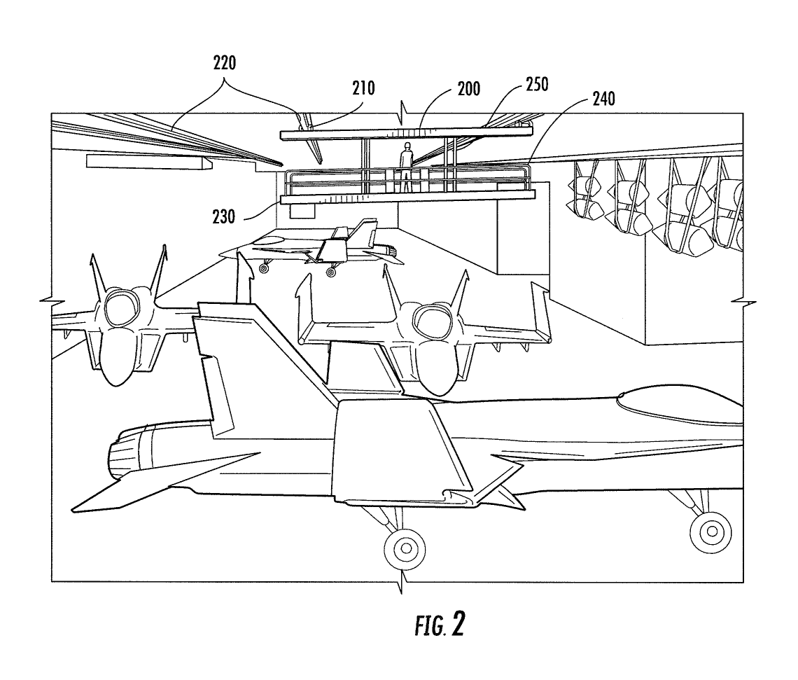

FIG. 1 shows overhead service platform 100 in accordance with some embodiments of the present invention. Overhead service platform 100 is an example of a staging assembly that can enable a worker and/or equipment to perform overhead service on one or more machines. Other examples of staging assemblies include, for example, scaffolding, or anything else that supports a person or piece of equipment in order to perform a service on a machine, building or other structure.

Overhead service platform 100 is shown as comprising floor 110, which is the bottom surface of platform 100 and may support at least one service worker 120 to stand on and/or perform various services. In some embodiments, floor 110 is at least a certain distance from the ceiling of the hangar bay (e.g., at least 6 feet).

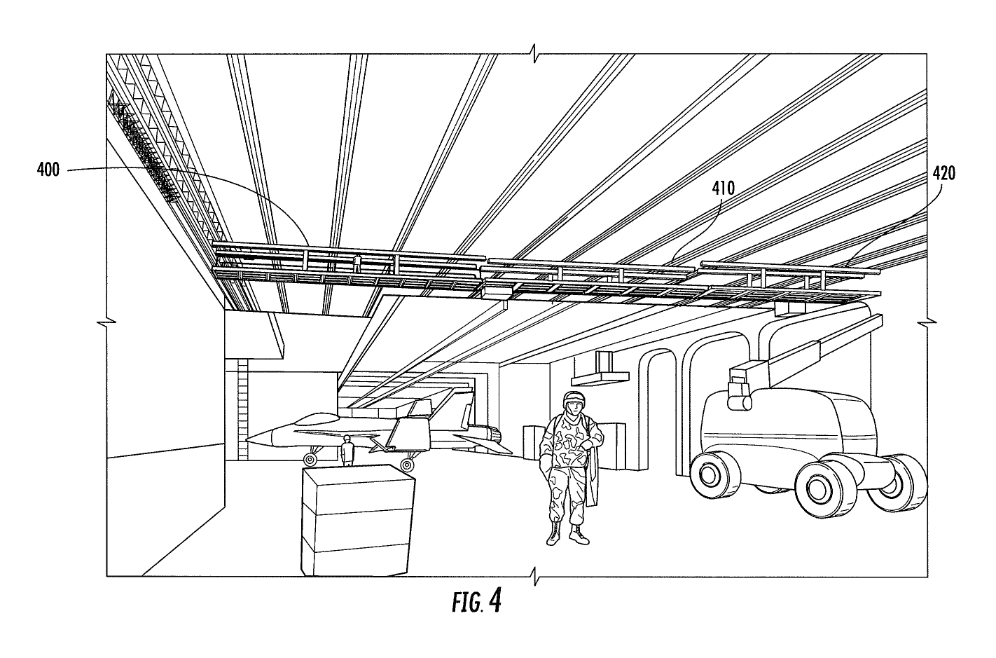

Floor 110 may also provide support for various equipment (such as, for example, a hoist assembly, fire extinguishing equipment assembly, lighting structure assemblies, tools, power supply, etc.), machinery, and/or anything else, some of which are discussed in more detail below with respect to FIGS. 4-9. Floor 110 can be made of any suitable material(s), such as metal, carbon fiber, plastics, or any combination thereof. Platform 100 and floor 110 can be strong enough to provide support for at least one service worker 120 and/or any equipment the service worker(s) may need to perform the service(s). Service worker 120 can be a person who is skilled in servicing aircraft, hangar equipment, or the hangar itself. Service worker 120 can also be skilled in controlling the movement and other functions of platform 100. Further, floor 110 or more generally, platform 100 may provide support for machines (that are being, e.g., hoisted, dragged, etc.), in addition to or instead of service worker 120. Floor 110 may be an expanded floor which allows service worker 120 to see through the floor, thereby enabling service worker 120 to observe, inspect and maintain aircraft, vehicles, vessels, machinery, and/or anything else (referred to herein as “machines”) located below platform 100.

According to some embodiments, platform 100 is suspended from at least one support structure 130 disposed in the overhead area of, e.g., the hangar bay. Each structure 130 can comprise, for example, one or more railings, beams, or other structural element strong enough to support one or more platforms (and any load it may bear), or a combination thereof. Structure 130 can be, for example, operably attached (e.g., directly and physically affixed and/or indirectly coupled to) the ceiling of the hangar bay, embedded into the walls of the hangar bay, positioned in various directions, a component of the hangar bay, and/or implemented in any other fashion. Each structure 130 may span an entire width and/or length of a hangar bay, or a portion thereof (e.g., at least 90% of the width and/or length).

According to some embodiments, each support structure 130 may be parallel to at least one other support structure 130. When two or more support structures 130 are implemented in the same overhead area and/or function as a single entity, it is referred to herein as a network of support structures. One or more other structures 130 (not shown) may span a portion of a width or length of the hangar bay, or a portion thereof (e.g., at least 90% of the width and/or length).

Structure 130 may define a traveling path for platform 100. As such, platform 100 may travel in various directions along at least one support structure 130, such as, for example, forward and backward (or, on a ship, aft to stem and vice versa). Some embodiments of platform 100 may be stationary despite being supported by at least one structure 130.

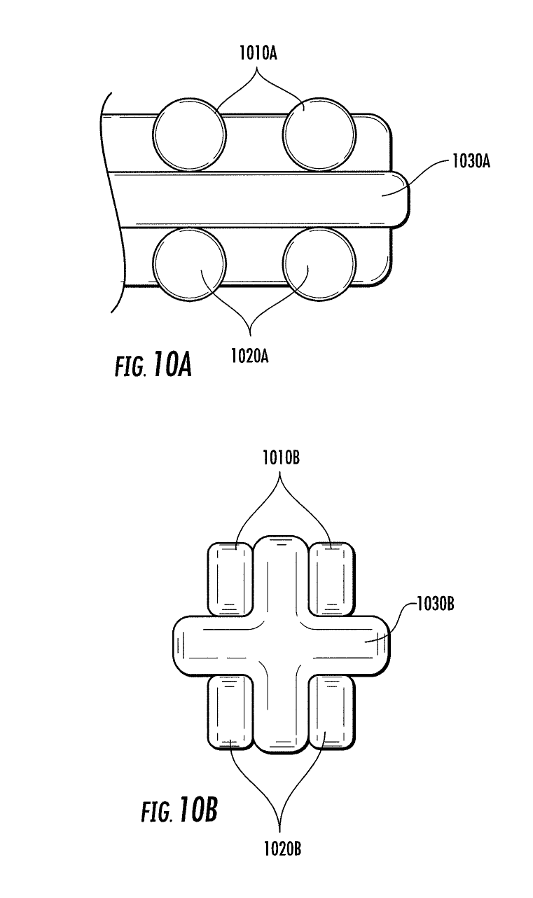

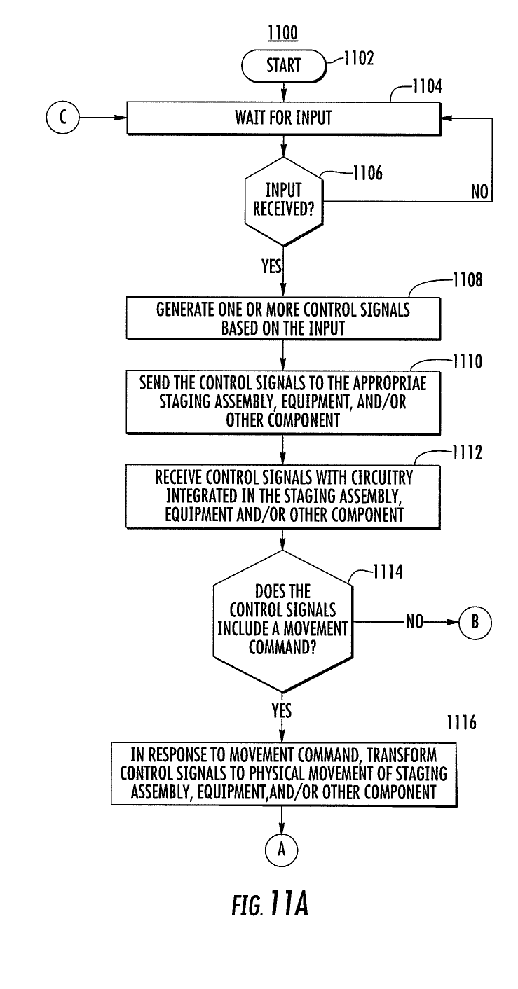

Structure 130 may be a permanent structure of the hangar bay. As such, platform 100 may be implemented relatively quickly in the hangar bay without any additional or extensive construction. Platform 100 may be suspended from structure 130 by at least one suspension system 140 that, in some embodiments, engages the flanges of structure 130. Exemplary embodiments of suspension system 140 are discussed in more detail in connection with, e.g., FIGS. 10A and 10B.

Platform 100 may further include first hand rail structure 150 and second hand rail structure 160. Hand rail structures 150 and 160 may be disposed opposite and/or parallel to each other and to floor 110. Hand rail structures 150 and 160 may be supported by a wall or additional railing structures, such as side rail structure 170. Although each side rail 170 is shown as being orthogonal to hand rail structures 150 and 160 and floor 110 of platform 100, each side rail 170 can extend outwardly in any direction from one or more of structures 150 and 160 and/or floor 110 and be used to support hand rail structures 150 and 160. In some embodiments, suspension system 140 may be physically connected to a portion of first and second hand rail structures 150 and 160. Hand rail structures 150 and 160 may provide security and stability to service worker 120 as the platform moves about the hangar bay along a traveling path defined by at least one structure 130.

Further, hand rail structures 150 and 160 of the platform 100 may support one or more service workers 120 as they perform services on the machines located inside or otherwise accommodated by the hangar bay. For example, one or more service workers 120 may reach through the floor, or lean over or under hand rail structures 150 and/or 160 to perform various services on the machines or infrastructure of the hangar bay.

In some embodiments, hand rail structures 150 and/or 160, and/or additional railing structures (not shown), may be configured to allow a service worker 120 to attach a safety belt (not shown) thereto. In this regard, the service worker 120 may safely walk the length of platform 100, move onto other platforms, and/or perform various services with the safety belt traveling a long path defined by hand rail structures 150 and/or 160, and/or additional structures without having to reattach, change, or otherwise readjust the safety belt. In other embodiments, two or more service workers 120 may have their safety belts simultaneously attached to the same railing.

Platform 100 and each structure 130 may be made of any suitable material(s) such as, for example, aluminum, carbon fiber, plastics, other metal, or any combination thereof. The material(s) of platform 100 may cause platform 100 of one embodiment to be relatively light weight, yet strong enough to support and accommodate, for example, one or more service workers 120, equipment, machinery (such as a hoist assembly, fire extinguishing equipment assembly, lighting structure assemblies, and/or the like), and/or any combination thereof. Further, platform 100 may facilitate the pickup and/or relocation of machines throughout the hangar bay. Moreover, various types of platforms may also facilitate unobstructed maintenance, inspection, and/or other types of services for machines.

The movement and other operations of platform 100 may be driven by various means. For example, one or more pneumatic mechanisms can be used to move and operate platform 100. Using a pneumatic mechanism can help avoid, e.g., electrical fires, which becomes more important when in a confined hangar bay or other space that contains flammable materials and expensive equipment. In addition, the movement and/or operation of platform 100 can also be driven by at least one hydraulic mechanism and/or an electrical mechanism (while providing measures to prevent electrically sparked fires).

The mechanism used to drive platform 100 may be operated in any of a number of manners. For example, the drive mechanism of platform 100 may be manually operated by one or more hangar bay workers (such as, e.g., one or more service workers 120 on the platform 100, workers located elsewhere inside the hangar bay, and/or workers outside the hangar bay at a different location). The one or more workers may operate the drive mechanism(s) to move platform 100 forward, backward, left, right, up, down, in any other direction platform 100 is able to travel, as well as control the velocity (e.g., faster, slower, and cease all movement) of platform 100.

At least one control panel for the drive mechanism(s) may be implemented on platform 100, elsewhere in the hangar bay, and/or at a location outside the hangar bay. In this regard, the control panels can send control signals, allowing one or more service workers 120 and/or one or more other workers located in the hangar bay, or at one or more other locations outside the hangar bay to control the movement of each platform 100. The control signals can cause the system to controllably transform the electric signals into physical movement and/or other operations of the platform 100.

A source of power (not shown) may also be supplied to each platform 100, including the beam crawler drive mechanism. The source of power may be, for example, a pneumatic mechanism, a hydraulic mechanism, an electrical mechanism, and/any other suitable mechanism. In some embodiments, the source of power may be disposed onboard the platform 100. In other embodiments, the source of power may be disposed off of platform 100 at a location inside and/or outside the hangar bay. As such, the source of power may be coupled to the platform via a cabling assembly, a tubing assembly, or any other suitable component that minimally impacts (if at all) the mobility of platform 100.

In some embodiments, the drive mechanism of platform 100 may be automatically controlled by a specially configured processing unit, and/or other electrical device(s). For example, an automated drive mechanism may be implemented using one or more sensor assemblies, computer software, specialized hardware, specialized firmware, or a combination thereof. Further, the hangar bay can include special and/or dedicated areas for storing at least one platform 100, and thus maintain a more organized, cleaner, efficient, and safer working environment for the workers.

The size and features of each platform 100 can vary to accommodate various numbers of service workers 120 and/or based on the type of service to be performed. For example, platform 100 illustrated in FIG. 1 may safely accommodate three or more service workers 120. The other embodiments of platform 100 may be designed to accommodate only one or two service workers (with their tools and equipment). For example, the platform 100 may be a one-man inspection platform or a two-man maintenance platform.

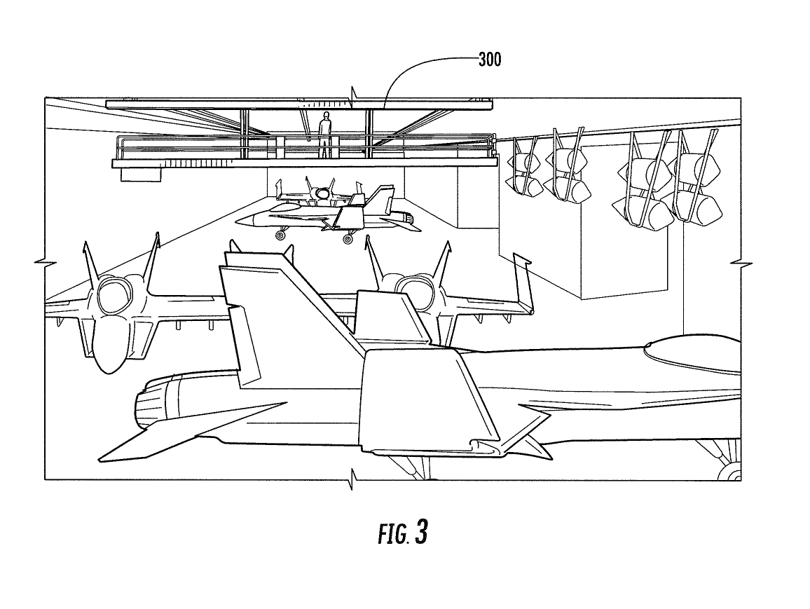

FIG. 2 shows another embodiment of an overhead service platform, namely, platform 200, in accordance with some embodiments of the present invention. Platform 200 is shown as being designed for one or two workers and any equipment (e.g. tools, safety strap, power supply, etc.) that may be needed. Platform 200 is shown as being suspended from at least one railing or high beam support structure, namely structure 220, and includes suspension system 210, floor 230, as well as first and second railing structures 240. Each of suspension system 210, structure 220, floor 230, and railing structures 240 can function the same as or similar to the corresponding component of platform 100, discussed above.

Platform 200 may also include at least one pole assembly 250 comprising, for example, at least four poles disposed in a rectangular fashion. Pole assembly 250 may be used to provide additional safety to a service worker as platform 200 travels along a railing or apparatus, such as support structure 220. The service worker may also, for example, connect a harness to or simply hold a part of pole assembly 250 and use pole assembly 250 as a support mechanism while the service worker leans closer to service (e.g., construct, inspect, repair, etc.) a machine (which may be located in the hangar bay). A one-man inspection platform, such as platform 200, may be designed and configured to be (relatively) light weight and better suited to maneuver over and around the machines below with no more than one or two service workers. Some of the smaller platforms, like some the larger platforms discussed herein, may be stored in predetermined locations throughout, e.g., the hangar bay or elsewhere.

FIG. 3 shows another example of an overhead service platform, namely platform 300, that is in accordance with some embodiments of the present invention. Similar to platform 100, platform 300 is shown as being suspended from at least one railing or high beam support structure. Platform 300, like some of the other platforms discussed herein, may also include a suspension system, a floor, first and second railing support structures, and a pole assembly, such as those discussed above. Platform 300 is shown as being designed for utilization by a few (e.g., at least two, but less than ten) service workers to perform maintenance and/or the like of machines located in and/or accommodated by the hangar bay. As such, platform 300 may function substantially similar to platforms 100 or 200, but be designed and optimized for simultaneous use by a few workers.

FIG. 4 shows an example of multiple platforms designed to collectively span nearly the entire width of a hangar bay (e.g., at least 95%) according to some embodiments of the present invention. As such, while multiple platforms may be disposed in a manner that together they span the nearly the entire width of the hangar bay, the length of each individual platform spans only a relatively small portion (e.g., 5% or less) of the width of, e.g., the hangar bay. Each of the multiple platforms may be the same or different size, each may be used to perform the same or different services, and each may function independent from or dependent on another platform's functionality.

For example, in some embodiments, three platforms, namely platforms 400, 410 and 420 of FIG. 4, may collectively span the entire width of a hangar bay, or a portion thereof (e.g., at least 90% of the width of the hangar bay). In other embodiments, one, two, four or more platforms, based on the size of the platform and/or the size of the hangar bay or other area, may be disposed in a manner to collectively span at least most of the width of the hangar bay or other area, or a portion thereof. When platforms are installed in a hangar bay, each platform can be disposed adjacent to or in close proximity with another platform, leaving little to no space between each adjacent platform (e.g., between platforms 400 and 410, and/or between platforms 410 and 420). The workers may then move, for example, from platform 400 to platform 410 to platform 420 and back again, thereby allowing the platforms to collectively function as a single entity, while each platform individually retains at least some of the advantages (e.g., mobile, light weight, specialized for particular function(s), autonomous, etc.) of being smaller than the width of the hangar bay (e.g., each being less than 50% of the width of the hangar bay and collectively more than 90% of the width of the hangar bay).

To enable workers and equipment to easily move among two or more platforms above one or more machines in a hangar bay or other area, some or all of the platforms may include one or more gate assemblies (not shown) at one or more end portions of each platform. A gate assembly, like a door to a room, can be positioned perpendicular to the bottom/support surface of the platform, between the platform's hand rail structures. A second gate assembly may be positioned at the opposite end of the platform and oriented (relative to the platform's floor and rails) in the same manner.

When, for example, two or more platforms are positioned adjacent or in close proximity to one another (as shown in, e.g., FIG. 4), a gate assembly of each platform can be opened thereby allowing one or more service workers to travel from one platform to another and, in some embodiments, equipment can travel from one platform to another. One or more of the gate assemblies may also include its own locking mechanism or portion thereof (that physically and securely couples the two platforms together). In some embodiments, the locking mechanism is independently operated (manually or automatically) and separate from one or more of the gate assemblies.

When coupled securely together (by means of, e.g., a locking mechanism), the platforms may be operated (e.g. moved, etc.) as a single entity, even if the platforms can each function independently when decoupled. For example, when open and in the secured position, the gate on the second end portion of the first platform and the gate on the first end portion of the second platform, can allow a service worker to easily and safely travel back and forth between the first platform and the second platform.

The ability to secure and unsecure independent platforms may enable workers to perform multiple machine services, such as, for example, maintenance, construction, and/or the like, in parallel (e.g., simultaneously) without unnecessary obstruction (such as additional scaffolding), even in a crowded environment where two or more machines are located in close proximity one to another, while rocking with the sea. Although FIG. 4 shows three platforms, any number of platforms may be installed throughout the hangar bay and collectively (and/or individually) span the entire width of the hangar bay (or at least 90% thereof) in one or more places of the hangar bay. Accordingly, embodiments of the present invention allow services to be simultaneously performed throughout, for example, at least ninety percent of the hangar bay.

In some embodiments, the movement and/or other operations of multiple platforms may be synchronized. For example, the multiple platforms can be moved at the same time while each platform maintains its position relative to another platform. In some embodiments, this may be accomplished with circuitry that establishes a prioritized hierarchy of each platform. For example, platforms 400, 410 and 420 may each comprise their own dedicated circuitry and, after their circuitry determines that they are disposed in close proximity or physically coupled to one another (as discussed above), the platforms' circuitry can assign or assume a preconfigured priority respective to the other platform(s). For example, platform 400 may have a priority of high, platform 410 may have a priority of medium, and platform 420 may have a priority of low, relative to each other. The highest priority platform may function as the master of the lower priority platforms, thereby making the other platforms its slave devices. Similarly, the medium priority platform may function as the master of the low priority platform. Accordingly, some commands received by the highest priority platform can be relayed to the lower priority platforms. For example, when coupled together, platforms 400, 410 and 420 may collectively span that least 90% (and/or some other portion) of the width of the hangar bay (depending on how the hangar bay is shaped and sized). Platforms 400, 410 and 420 may all move at the same time (while continuing to span the at least a portion of the width of the hangar bay), in response to the master platform (e.g., platform 400) receiving a move command (from another system, a service worker, etc.).

In some embodiments, the platforms may retain their master-slave relationship, even when not physically coupled together when, e.g., the platforms are electrically coupled wirelessly (using Bluetooth, 802.11 protocol(s), and/or by any other means). For example, platform 400 may be disposed in a first position, platform 410 may be disposed in a second position, and platform 420 may be disposed in a third position, each being separated by a predetermined distance (e.g. six inches, one foot, two feet, 100 feet, within the same hangar bay, etc.), and may all move at the same time and each maintain its position relative to one another. In some other embodiments, a subset of the platforms (e.g., only two of the three platforms 400, 410 and 420) may move at the same time and maintain their master-slave relationship and/or position relative to one another.

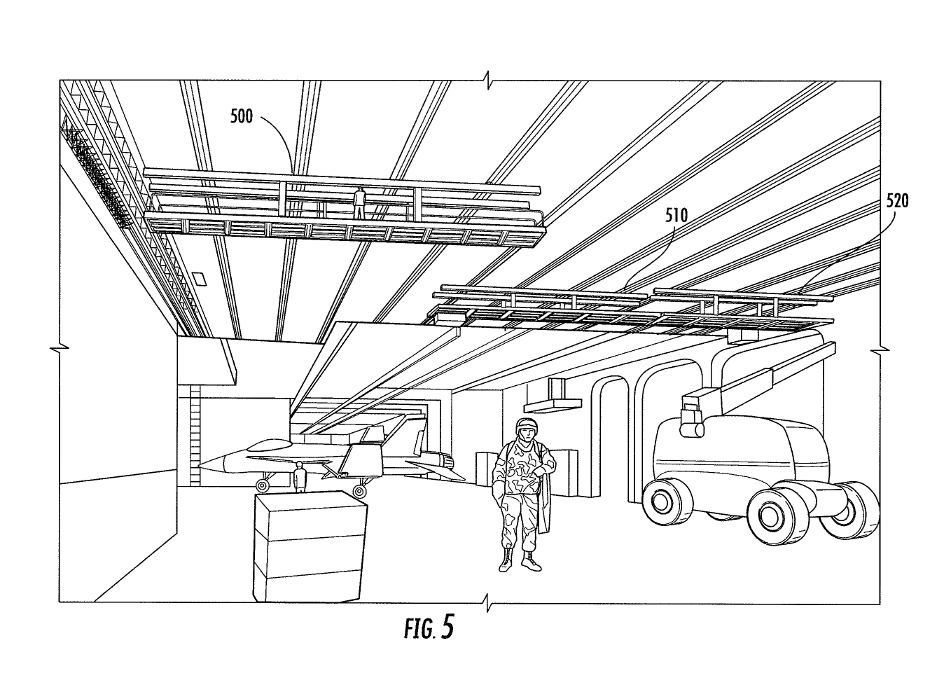

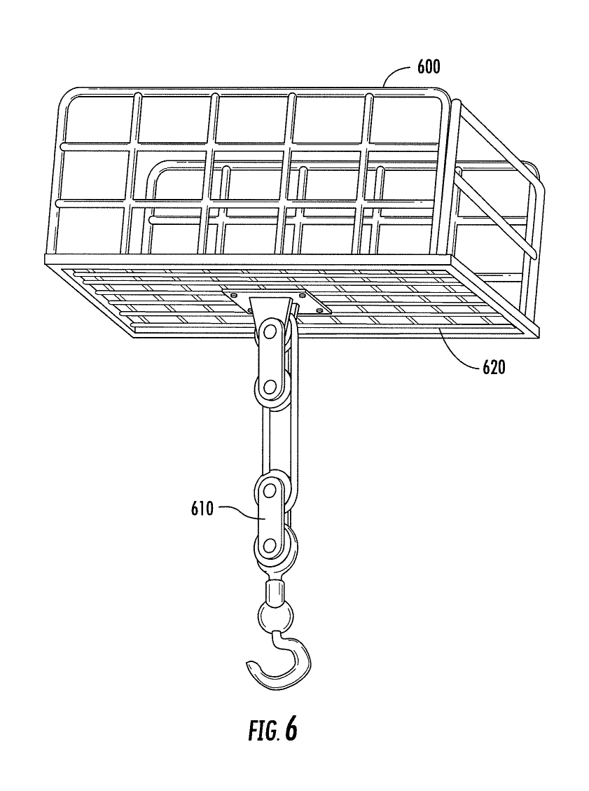

FIG. 5 shows an example of multiple platforms 500, 510 and 520, positioned after moving independently. Platforms 500, 510 and 520 may be the same as or substantially similar to any other platform or set of platforms discussed herein, however, in FIG. 5 platforms 500, 510 and 520 have been moved (or are moving) throughout the hangar bay independent of one another. For example, platform 500 may travel along the path defined by the railing or high beam structure in the ceiling of the hangar bay, while platforms 510 and 520 remain stationary (i.e., do not move). Similarly, although not shown in FIG. 5, platform 510 may move while platforms 500 and 520 remain stationary. As another example, two or more platforms may be moving at different times, independent of the movement of the one or more other platforms. This can enable, for example, workers to service equipment in multiple areas of the hangar bay simultaneously. For example, platform 500 may accommodate three service workers performing construction at one location of the hangar bay, while platform 510 accommodates one service worker performing inspection at a different location and platform 520 accommodates two service workers performing maintenance at yet a third location.

Further to the above discussion, each overhead service platform may include various equipment, such as, e.g., one or more specialized components, including fire extinguishing assemblies, hoist assemblies, lighting structure assemblies, any other type of equipment, or any combination thereof. For example, one platform may support one or more service workers and include fire extinguishing equipment assemblies, a hoist assembly, a lighting structure assembly, and/or any other equipment.

FIG. 6 shows platform 600 comprising a mobile hoist assembly according to some embodiments of the present invention. Similar to platform 100 of FIG. 1 or any other platform discussed herein, platform 600 may be suspended from at least one railing or high beam support structure. Platform 600 may include, for example, a suspension system, floor 620, first and second railing structures, and a pole assembly, similar to or the same as those discussed above. Further, platform 600 may include at least one piece of equipment, such as mobile hoist assembly 610, which may be mounted to the underside of floor 620. In some embodiments, hoist assembly 610 may be mounted at or proximately to the center of gravity of floor 620 and/or platform 600.

Floor 620 can include portions that are expanded to allow a worker (and/or machine, such as a video camera, infrared sensor, or anything else) to see through floor 620. As an expanded floor, spaces and/or see-through material (like clear plastic, glass, etc.) are integrated into floor 620. The size and amount of spaces in floor 620 can vary depending on the desired strength of floor 620. The intended function(s) of platform 600 can be one consideration in determining the size and number of spaces integrated into floor 620. For example, a platform designed only for inspection can include a floor that is 90% space and 10% support, as such an inspection platform will only need to support, in some embodiments, only one or two workers and no heavy equipment. As another example, a platform designed to hold a number of service workers, their tools and some other equipment may have spaces comparable to the expanded portions of floor 620 shown in FIG. 6, which may enable the service workers to see and reach through the floor, while still being strong enough to bear the load of the workers, their tools and the other equipment.

Because the amount of space (based on the size and number of spaces) can be inversely proportionate to the strength of the floor (i.e., the more of the floor that is space, the weaker the floor becomes), some embodiments of floor 620 can include one or more portions that have a smaller percentage of space (e.g., a portion that has smaller spaces or no space at all) where, for example, hoist assembly 610 is mounted and additional strength is needed. While providing less, smaller or no spaces at one or more specific locations of a platform's floor may reinforce and/or provide strength where it is needed most, it is often done at the expense of visibility and accessibility through the floor. However, in some embodiments, one or more other portions of floor 620 may still include an adequate amount of space (potentially including transparent material) comprised of one or more various sizes, which allow a worker and/or instrument to see through and/or reach through (at least portions of) floor 620.

Hoist assembly 610 may be able to hoist loads weighing, for example, up to two tons and may be utilized to perform various functions. For example, hoist assembly 610 may be used to open a canopy and/or lift equipment, engines and/or components, machines or various other loads located in the hangar bay or elsewhere. Hoist assembly 610 may also be utilized to transport equipment, machines, and/or any other load from one area of the hangar bay to another. As another example, hoist assembly 610 may be utilized to access various aircraft, vehicles, vessels, equipment, machinery, and/or the like located throughout the hangar bay, irrespective of their position with respect to one another, (i.e., whether proximate or distant). Mobile hoist assembly 610 may be operated in response to command signals generated by electrical devices being used by one or more service workers standing and/or traveling on platform 600 or by one or more other workers located inside the hangar bay or at a different location.

Similar to the movement of platforms discussed above, while the electrical operation can be driven by analog or digital signals generated by one or more various electrical components (including, e.g., a computer, mobile device, keypad, joystick, mouse, touchpad, multi-touch screen, and/or any other device or combination thereof), the physical movement and/or operation of mobile hoist assembly 610 may be driven by various means (and may be in response to one or more commands generated by one or more of the electrical components). In some embodiments, for example, the physical movement and/or operation of mobile hoist assembly 610 can be driven by a pneumatic mechanism. As another example, the physical movement and/or operation of the mobile hoist assembly 610 can be driven by a hydraulic mechanism. As yet another example, the physical movement and/or operation of the mobile hoist assembly 610 may be driven by an electrical mechanism. In some embodiments, the mechanism to drive mobile hoist assembly 610 may be manually operated by, for example, one or more hangar bay workers. In some embodiments, the mechanism that drives mobile hoist assembly 610 may be a combination of two or more of pneumatic, hydraulic, and/or electrical mechanisms. A plurality of platforms, configured like platform 600 (with, e.g., mobile hoist assembly 610) may be provided throughout the hangar bay.

The mechanism that drives mobile hoist assembly 610 may also be controlled automatically by a specialized computer system. This automated control mechanism may be implemented in various fashions, including one or more sensor assemblies, computer programs, hardware, firmware, or any specialized combination thereof. For example, a central control computer can be configured to generate and send automated commands to a platform and its hoist assembly, which collectively cause the platform to move throughout the hangar bay and have its hoist assembly lift, move and lower machines. The central computer can also store, for example, in one or more local and/or remote electrical storage components a record of each action of the central computer or any other component, the location of each piece of equipment, the location of each machine (and component thereof), the location of each platform, among other things.

As another example, the central computer can be electrically coupled to (via a wire, wirelessly, and/or by any other means) fire detecting sensors (not shown), which can be placed throughout a hangar bay. As mentioned above, the central computer can be configured to track the current location of each platform (which the central computer can control) as each platform moves within the hangar bay. In response to a fire detecting sensor being triggered and generating a corresponding output, the central computer can generate the appropriate drive command, determine which platform to send the drive command to (e.g., the platform nearest the sensor with a functional fire extinguishing assembly), and send the drive command to the appropriate platform. The drive command generated by the central computer may override or be subservient to one or more other commands (such as a drive command generated by a joy stick used by the service worker standing on the platform, a command generated by a master platform's control circuitry, etc.). Once the central control computer determines that the fire extinguishing apparatus is in proximity to the location of the fire (and/or the fire detecting sensor), the central computer can generate an equipment activation command that causes the fire extinguishing assembly to be activated and douse the fire with fire retardant agents.

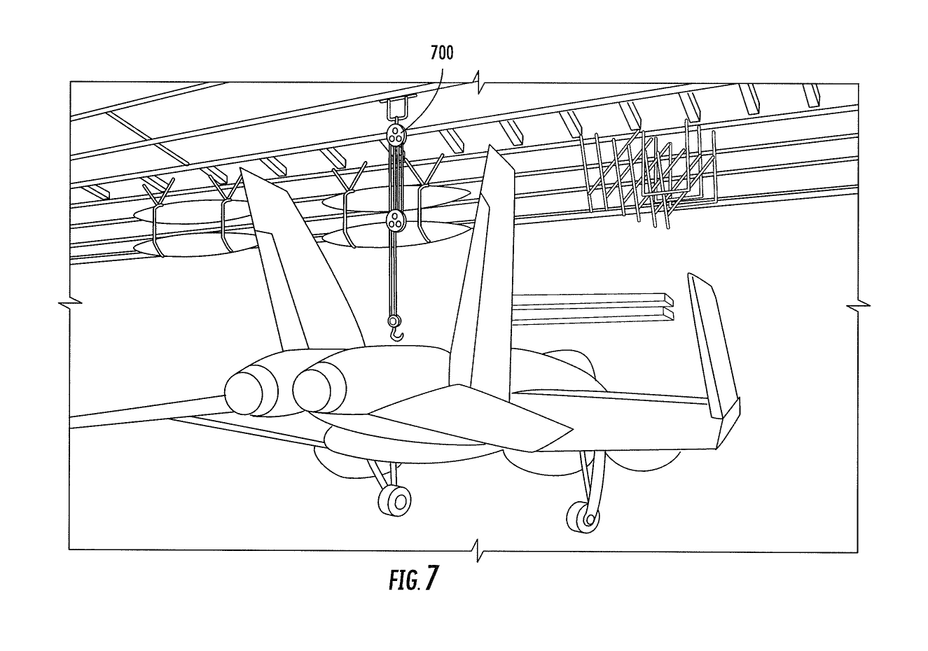

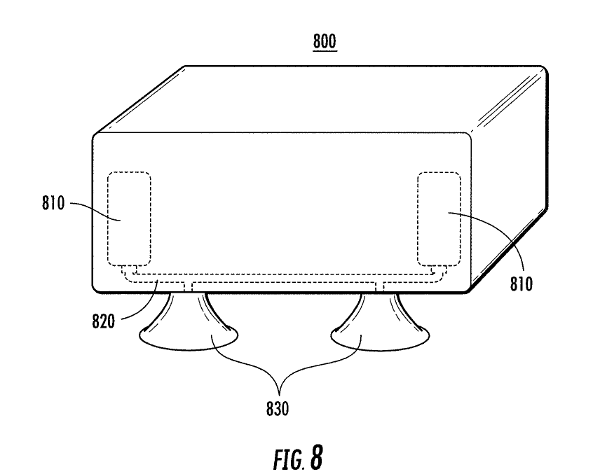

FIG. 7 shows a hoist assembly 700, which is separate from any platform in the hangar bay. Hoist assembly 700 may function the same as or similar to hoist assembly 610, despite being mounted to at least one railing or other high beam support structure instead of or in addition to being mounted on a platform, such as platform 600.

For example, FIG. 7 shows mobile hoist assembly 700, which is separate from any platform in the hangar bay. Mobile hoist assembly 700 may be directly suspended from at least one railing and/or any other high beam support structure. Mobile hoist assembly 700 may also be mounted to an intermediate structure, wherein the intermediate structure is suspended from at least one railing and/or other high beam support structure.

One or more workers located inside the hangar bay or elsewhere may operate hoist assembly 700. As such, hoist assembly 700 can be locally and/or remotely commanded to move up, down, slower, stop, faster, etc. from, for example, at least one railing or other high beam structure. In some embodiments, one or more additional mobile hoist assemblies (not shown) may be provided throughout the hangar bay. Similar to or the same as the movement and/or operation of the platforms discussed above, the functionality, movement, and/or operation of mobile hoist assembly 700 can be synchronized and coordinated with the functionality, movement, and/or operation of any other item in the hangar bay. For example, hoist assembly 700 can be configured to receive commands from a central control computer or be a slave to one or more platforms' integrated control circuitry. Further, the one or more mobile hoist assemblies can be moved and/or stored in one or more predetermined locations throughout the hangar bay and thus maintain a more organized, cleaner and safer working environment in the hangar bay.

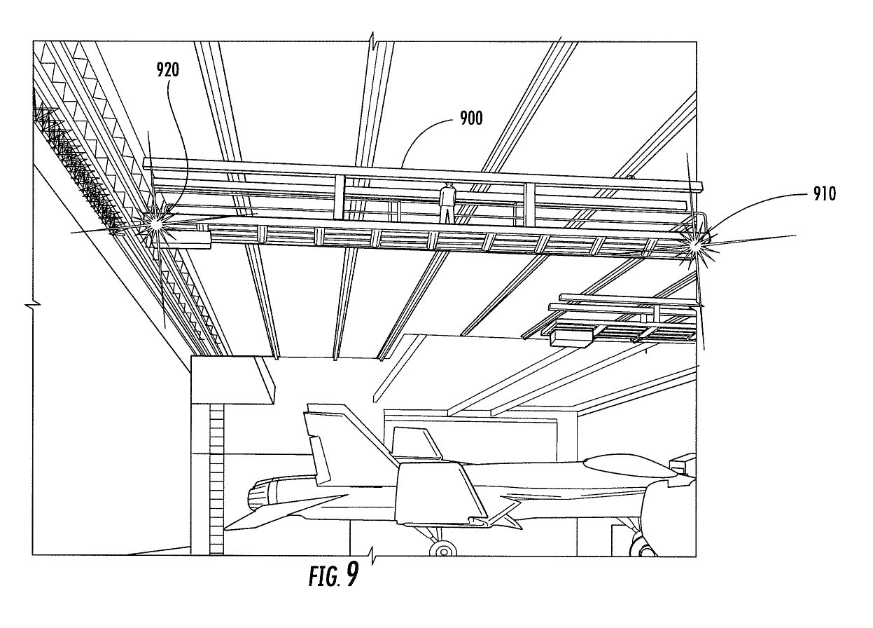

FIG. 8 shows a fire extinguishing equipment assembly 800 that can be physically and electrically coupled to a platform in accordance with some embodiments of the present invention. Fire extinguishing equipment assembly 800 may be suspended from, for example, at least one platform, railing and/or other high beam support structure. Fire extinguishing equipment assembly 800 may include one or more bottles 810 that may contain halon, and/or other fire suppressing agents. The platform that fire extinguishing equipment assembly 800 is affixed to may include additional railing support structures to provide further support and stability to the bottles 810. One or more conduits/tubing assemblies 820 may be connected to bottles 810 and be used to supply halon, or the other fire suppressing agents, to one or more nozzles assemblies 830 disposed on the underside of the platform to which fire extinguishing equipment assembly 800 is implemented. As such, the halon and/or other fire suppression agents may be dispensed through nozzles assemblies 830 when necessary. Fire extinguishing equipment assembly 800 may include various embodiments of nozzle assembly 830. In some embodiments, fire extinguishing equipment assembly 800 may only include nozzle assemblies having the same size and shape. In other embodiments, the platform may include multiple nozzle assemblies having various sizes and/or shapes disposed on the underside of each platform. In other embodiments, the platforms may include other fire extinguishing equipment in addition to or in the stead of the fire extinguishing equipment assembly 800. For example, some or all the platforms in the hangar bay may include equipment to dispense the fire suppression agents in addition to or instead of the nozzle assemblies 830, such as one or more hoses.

FIG. 9 shows platform 900 comprising lighting structure assemblies 910 and 920 in accordance with some embodiments of the present invention. Lighting structure assembly 910 may be similar to or the same as lightning structure assembly 920. The one or more lighting structure assemblies 910 and 920 may also be different. For example, lighting structure assemblies 910 and 920 may be dissimilar in power, operation, shape, type (fluorescent, incandescent, infrared, ultraviolet, etc.), color, etc. One or more of lighting assemblies 910 and 920 can also be a drop light, which can be lowered and/or raised automatically by the system and/or manually by a service worker.

Each lighting structure assembly may be supplied with electrical power by a cordless electrical power source, such as, for example, batteries, solar panel (if, e.g., hangar bay has an open or retractable roof), etc. In this regard, the mobility of the overhead service platform throughout the hangar bay may be enhanced due to any encumbrance that may be eliminated by removing electrical wires. Further, using batteries can allow service workers to travel from one area of platform 900 to another area (or platform), without electrical power cords or wires being in the way or presenting a safety concern.

As another example, a semi-cordless electrical power source may be utilized, which comprises one or more power generators disposed on one or more of the platforms. In this regard, a limited amount of carefully disposed electrical wires or cords may connect the electrical power source (e.g., generator) to lighting structure assemblies 910 and/or 920 without obstructing the travel path of the service workers throughout the network of the platforms.

As yet another example, one or more lighting structure assemblies 910 and 920 may be connected to stationary power supply outlets disposed throughout the hangar bay, using electrical power cords or wires. Nevertheless, the electrical power cords or wires may be carefully disposed on the platforms (e.g., integrated into conduits, or retractable wheels, below the floor of the platforms, and/or any other means possible), so as to not impede the mobility of one or more platforms and/or obstruct workers and/or equipment traffic throughout the hangar bay.

The operation of one or more lighting structure assemblies 910 and 920 may be manual, automated, or any combination thereof. In this regard, lighting structure assemblies 910 and 920 may be operated by the one or more service workers traveling on platform 900 or by a service worker located elsewhere inside the hangar bay or at another location. In automated embodiments, one or more of lighting structure assemblies 910 and 920 may be configured to turn on and/or off based on various criteria, parameters, and/or the like such as, for example, the illumination level in the hangar bay in general or at the current location of the platform 900, a security threat level to the ship (while out at sea), a command from a central control computer, or any combination thereof. The automated operation may be implemented by means of anything discussed herein, such as, for example, one or more sensors, computer programs, central servers, central computers, and the like. Further, the automated operation of the one or more lighting structure assemblies 910 and 920 may be based on manually-entered configurations, wherein, for example, one or more service workers may override the pre-programmed setting of lighting structure assemblies 910 and 920.

FIGS. 10A and 10B show two embodiments of a portion of a suspension system that uses support structures similar to structure 130 (of FIG. 1). FIGS. 10A and 10B are shown as beam crawlers, comprising a plurality of wheels, which can be operatively connected to, for example, a drive of assembly and other portions of of a staging assembly (not shown in FIGS. 10A and 10B).

While four wheels are shown in the embodiments of FIGS. 10A and 10B, other embodiments may include less (e.g., two) or more wheels. The wheels can be positioned to engage the flanges and/or other portion(s) of structure 130 (not shown in FIG. 10A or 10B), two wheels 1010A may be on the same side of a top portion of flange 1030A and two wheels 1020A may be disposed on the same side of a bottom portion of flange 1030A.

In other embodiments, such as the one illustrated by FIG. 10B, two wheels 1010B may be disposed on different sides of a top portion of flange 1030B and two wheels 1020B may be disposed on different sides of a bottom portion of flange 1030B. Any of the wheels discussed herein may be made of any suitable material(s) such as, for example, Teflon, metal, carbon fiber, plastic, or any combination thereof.

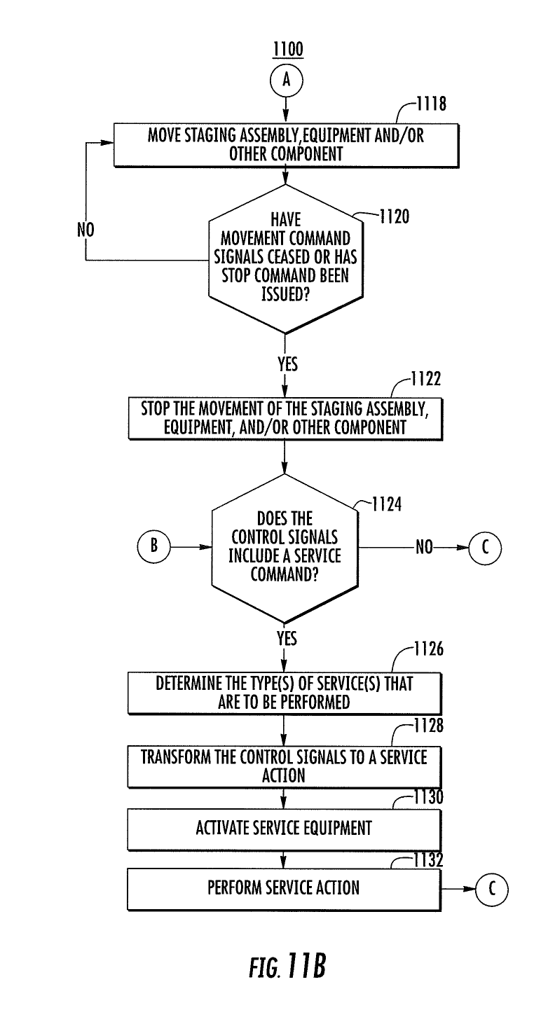

FIGS. 11A and 11B described below are flowcharts of a method and/or operation of a computer program product according to exemplary embodiments of the invention. It will be understood that each block or step of the flowchart, and combinations of steps in the flowchart, can be implemented by various means, such as hardware, firmware, and/or software including one or more computer program instructions. For example, one or more of the procedures described herein may be embodied by computer program instructions. In this regard, any, some or all of the computer program instructions that embody the procedures described herein may be stored by at least one of a memory device of each staging assembly (e.g., platform), piece of equipment (e.g., hoist assembly, lighting assembly, fire extinguishing assembly, etc.), and/or other component (e.g., central control processor, handheld device, etc.). The steps and/or corresponding instructions can be executed by one or more processors in any, some or all of those components. As will be appreciated, any such computer program instructions may be loaded onto any type of computer or other programmable logic device (e.g., hardware) to produce a machine, such that the computer or other programmable logic device create means for implementing the functions specified in the flowchart block(s) or step(s). These computer program instructions may also be stored in a computer-readable memory that can direct a computer or other programmable logic device to transform the electrical signals into one or more physical movements, actions and/or other functions, such that the instructions stored in the computer-readable memory produce an article of manufacture which implements the function specified in the flowchart block(s) or step(s). The computer program instructions may also be loaded onto a computer or other programmable logic device to cause a series of operational steps to be performed on the computer or other programmable logic device to produce a computer-implemented process such that the instructions executed on the computer or other programmable logic device provide steps for implementing the functions specified in the flowchart block(s) or step(s).

Accordingly, blocks or steps of the flowcharts may support combinations of means for performing the specified functions, and combinations of steps for performing the specified functions. It will also be understood that one or more blocks or steps of the flowchart, and combinations of blocks or steps in the flowchart, may be implemented by special purpose hardware-based computer systems that perform the specified functions or steps, or combinations of special purpose hardware and computer instructions.

In some exemplary embodiments, one or more of the systems and apparatuses described above may collectively and/or individually comprise one or more multiple processors configured to perform some or each of the operations described below. The processor may, for example, be specifically configured to perform the operations by performing hardware implemented logical functions, executing stored instructions, or executing algorithms for performing each of the operations.

FIGS. 11A-11B show exemplary process 1100 for enabling and performing automatic and/or manual overhead services on one or more machines. Process 1100 starts at step 1102.

Next is step 1104 at which the system waits for an input that generates one or more command signals. At step 1106 the processor periodically checks for such an input. The input can originate from, for example, a worker input device (such as, for example, a computer, mobile device, keypad, joystick, mouse, touchpad, multi-touch screen, and/or any device that may transform manual interactions into electrical signals, or any combination thereof), a sensor's output port (such as those discussed above, which may transform a physical stimuli into one or more electrical signals), and/or any other device. In response to determining that a command input has not been received, process 1100 returns to step 1104 and waits (till, e.g., the next or some other number of clock cycles).

In response to determining that a command input has been received, process 1100 advances to step 1108. The device that received the input (e.g., worker input device, sensor, etc.) and/or a device coupled to the device that received the input (e.g., a central control computer), or any other device configured to generate control signals based on the input, generates one or more control signals associated with the input(s) that were received at step 1106.

At step 1110, the one or more control signals are sent to the appropriate staging assembly or assemblies (e.g., one or more mobile platforms), equipment (e.g., mobile hoist assemblies), and/or any other components (e.g., a central data server that stores a record of all control signals that are generated). The control signals can be sent wirelessly, by means of a physical connection (e.g., metal wire, fiber optic cable, etc.), and/or by any other means. In some embodiments, the device that generated and sends the control signal may be integrated into the device that receives the control signals. For example, a staging assembly may include a joy stick that generates and sends a control signal to a drive assembly, which is also integrated into a staging assembly.

In some embodiments, the joy stick (e.g., the generating device) may also cause a central control processor (e.g., the sending device) to send a control signal to a drive assembly of a mobile platform (e.g., the receiving device) located remotely from the central control computer. The sending device may know where to send a control signal based on, for example, a virtual address or physical address of each receiving device. For example, each staging assembly, piece of equipment, and/or other component in a hangar bay can be associated with a virtual address (e.g., IP address, MAC address, or any other address used to route electronic communications) and/or a physical address. The virtual address may remain the same (regardless of the physical location of the device), while the physical address may change as the device moves throughout, e.g., the overhead area of a hangar bay. The hangar bay (or any other area in which a mobile staging assembly can be employed) may be divided into a virtual grid, wherein each cell of the grid (which may be, e.g., 10 feet by 10 feet) is assigned a physical address.

Next is step 1112 at which the circuitry integrated into the staging assembly, equipment and/or other component(s) receive the control signals. The receiving circuitry will parse the bits of data comprising the control command signal(s) and determine at step 1114 whether or not the control signal(s) include a movement command for the device associated with the receiving circuitry. For example, a control signal can include a command that causes a mobile platform, which is stationary (i.e., not moving), to move forward at a predetermined speed. As another example, the control signal can include a command that causes a moving mobile platform to stop moving and/or slow down.

In response to determining that the control signal(s) include a movement command, process 1100 proceeds to step 1116, at which the at least one receiving device transforms the control signal(s) into some sort of physical movement, which may include the cessation of any previously occurring movement.

Process 1100 continues in FIG. 11B at step 1118. The receiving device (e.g., staging assembly, equipment and/or other component) moves in accordance with the movement command embedded in the control signal(s).

Next is step 1120, at which the receiving device's circuitry determines whether the movement command signals have ceased (if the receiving device is configured to move or remain stationary only when receiving a corresponding command) or whether a stop command has been received (if the receiving device is configured to move or remain stationary until a new command is issued). If the circuitry determines that no such command has been issued, process 1100 returns to step 1118 and the device continues to move (or remain stationary).

In response to determining that the movement command signals have ceased or a stop command has been issued, process 1100 proceeds to step 1122. At step 1122, the device stops moving if it was moving, or starts moving if it was stationary.

Next is step 1124, which also follow step 1114 after a determination is made that the control signal(s) lack a movement command for a particular receiving device. At step 1124, a determination is made as to whether or not the control signal(s) include a service command. A service command may be any type of electrical signal that causes a piece of equipment and/or other device to perform a service. If the control signals do not include a service command, process 1100 returns to step 1104 and waits for another input.

In response to determining that the control signal(s) include at least one service command, process 1100 proceeds to step 1126 and determines the type or types of service(s) that are to be performed. For example, the types of services may include hoisting a component (e.g., engine) out of a machine, inspecting a machine (e.g., taking pictures, executing other types of imaging scans, etc.), extinguishing a fire, providing enhanced lighting, or anything else that may assist a service worker or other user in performing a particular function

Next is step 1128, wherein the control signals are transformed into the service action. At step 1130, the service equipment is activated and at step 1132 the service is performed.

Many modifications and other embodiments of the present invention set forth herein will come to mind to one skilled in the art to which these embodiments pertain having the benefit of the teachings presented in the foregoing descriptions and the associated drawings. For example, various steps and/or components could be added to, omitted from and/or combined within process 1100 and/or any of the embodiments discussed herein. Therefore, it is to be understood that the embodiments of the invention are not to be limited to the specific embodiments disclosed herein and that modifications and other embodiments are intended to be included within the scope of the appended claims. Although specific terms are employed herein, they are used in a generic and descriptive sense only and not for purposes of limitation.

That which is claimed:

1. An apparatus for enabling the performance of overhead service, comprising:
a staging assembly, comprising:
a support surface;
a first railing structure:
disposed on a first side of the staging assembly; and
extending outward from the support surface; and
a second railing structure disposed on a second side of the staging assembly orthogonal to the support surface, wherein the second side is opposite the first side relative to the support surface;
a suspension system operatively connected to the staging assembly, wherein the suspension system is configured to engage at least one overhead support structure; and
a drive mechanism that is configured to drive the staging assembly along a path defined by the at least one support structure.

2. The apparatus of claim 1, wherein the staging assembly further comprises:
a first gate assembly on a third side of the staging assembly, wherein the first gate assembly extends outwardly from the support surface and between the first railing structure and second railing structure.

3. The apparatus of claim 2, wherein the staging assembly further comprises:
a second gate assembly on a fourth side of the staging assembly, wherein the second gate assembly:
extends outwardly from to the support surface,
is between the first railing structure and second railing structure, and
is opposite the first gate assembly relative to the support surface.

4. The apparatus of claim 1, wherein the staging assembly further comprises:
a locking mechanism configured to enable the staging system to be physically coupled to a second staging assembly.

5. The apparatus of claim 1, wherein the staging assembly further comprises:
a locking mechanism configured to enable the staging system to be electrically coupled to a second staging assembly.

6. The apparatus of claim 1, wherein the staging assembly further comprises a fire extinguishing assembly.

7. The apparatus of claim 1, wherein the staging assembly further comprises a hoist assembly.

8. The apparatus of claim 1, wherein the support structure is operably attached to a ceiling of a land-based hangar bay.

9. The apparatus of claim 1, wherein the support structure is operably attached a ceiling of a ship's hangar bay.

10. The apparatus of claim 1, wherein the staging assembly comprises at least one cordless light assembly.

11. A method of enabling the performance of overhead service, comprising:
receiving a movement control signal at a drive mechanism;
in response to receiving the movement control signal, transforming the movement control signal into physical movement of a staging assembly along at least one overhead support structure, wherein the staging assembly is suspended from the at least one support structure;
determining that a service needs to be performed; and
in response to determining that a service needs to be performed, performing the service.

12. A method of claim 11, wherein determining that the service needs to be performed comprises receiving an input from a worker input device.

13. A method of claim 11, wherein determining that the service needs to be performed comprises receiving an output from at least one sensor.

14. A method of claim 13, further comprising:
determining a type of the service; and,
wherein performing the service comprises activating equipment that is configured to perform the type of the service.

15. A method of claim 13, further comprising:
determining where the service needs to be performed;
generating the movement control signal based on where the service need to be performed relative to the staging assembly; and
sending the movement control signal to the drive mechanism.

16. The method of claim 13, wherein:
the type of the service includes extinguishing a fire; and
the performing the service comprises activating a fire extinguishing assembly.

17. The method of claim 13, wherein:
the type of the service includes lifting a load; and
the performing the service comprises activating a hoist assembly.

18. A system for enabling the performance overhead service in a hangar bay, comprising:
at least two platforms, wherein a collective length of the at least two platforms equals at least 90% of a width of the hangar bay; and
a network of support structures operably attached to the hangar bay's ceiling, wherein the network of support structures:
support the at least two platforms; and
provide a pathway for the at least two platforms to move along the support structure and throughout the hangar bay's overhead area.

19. The system of claim 18, wherein the at least two platforms are configured to move as a single unit along the ceiling throughout the overhead area.

20. The system of claim 18, wherein the at least two platforms are configured to move independently along the ceiling throughout the overhead area.
